(19) United States
(12) Patent Application Publication
(10) Pub. No.: US 2024/0182235 A1
(43) Pub. Date: Jun. 6, 2024

(54) UNIVERSAL APPARATUS FOR CARRYING ITEMS

(71) Applicant: Frank David Lee, Lansing, MI (US)

(72) Inventor: Frank David Lee, Lansing, MI (US)

(21) Appl. No.: 18/075,415

(22) Filed: Dec. 6, 2022

(51) Int. Cl. B65D 88/22; B65D 81/03; B65D 85/64; B65D 88/16

(52) U.S. Cl. CPC B65D 88/22; B65D 81/03; B65D 85/64; B65D 88/1681

(57) ABSTRACT

An apparatus that provides a durable, reusable device with handles and adjustable straps and connectors, which may be padded internally, the external layer made of water-shedding or water-proof fabric, and thus able to effectively secure for transport a wide range of large, heavy or awkward items, without requiring a pre-cut or custom fit. The invention allows for a multiplicity of configurations and sizes, providing a virtually universal protective bag, with adjustable straps and connectors, and multiple built-in handles, to safely and securely transport any type of furnishing item, including but not limited to appliances, beds, sofas, loveseats, tables, shelves, entertainment centers, cabinets, dressers, and armoires.

### CROSS REFERENCE TO RELATED APPLICATION

This application claims the benefit of U.S. Provisional Patent Application No. 63/265,102, filed on Dec. 8, 2021, which is incorporated herein by reference in its entirety.

This application claims the benefit of U.S. Provisional Patent Application No. 63/429,460, filed on Dec. 1, 2022, which is incorporated herein by reference in its entirety.

### FIELD

The present disclosure is generally directed to devices for carrying heavy items, and more specifically to devices for carrying furnishings, appliances and other large or awkward items in a safe, secure and protected manner.

### BACKGROUND OF THE INVENTION

Heavy items, such as mattresses, appliances and other pieces of furniture, can be awkward and cumbersome to lift and move. Holding them securely during a move can be a great challenge for the mover, the security of the item, and the protection of adjacent fixtures and surfaces. The standard manner of lifting and moving a heavy item can be quite physically stressful for the mover, and can lead to injury. Conventional solutions for moving heavy items such as mattresses, for example, require either grabbing side straps (if present), or contorting a mover's body to an appropriate but awkward position so as to securely grab the mattress in the best way possible for moving, which can lead to high physical stress levels and potential injury. Moreover, if an item is dropped or falls, nearby fixtures or walls may be damaged. Yet another issue is the security of the item, which may become damaged if it is exposed or uncovered during transport. Heretofore the common solutions have been plastic covers, which are not cost effective, shrink wrap, which is one-off and costly with frequent use, and old, often dirty moving blankets, which can easily shift position during carry, transport, and move, thus endangering both the mover and the item. Further, an exposed item runs the risk of being damaged during a move by the movers, other fixtures or surfaces, dirt, rain and other elements.

### SUMMARY

Disclosed herein as the present invention is an apparatus that overcomes the aforementioned difficulties and others by providing a durable, reusable device with handles and adjustable straps and connectors, which may be padded internally, composed of water-shedding (or even water-proof) fabric externally, and able to effectively secure for transport a wide range of large or heavy items, without requiring a pre-cut or custom fit. The invention allows for a multiplicity of configurations and sizes, providing a virtually universal protective bag, with adjustable straps and multiple built-in handles to safely and securely transport any type of furnishing item, including but not limited to appliances, beds, sofas, loveseats, tables, shelves, entertainment centers, cabinets, dressers, and armoires.

These and other features, aspects, and/or advantages of the present disclosure will become better understood with reference to the following detailed description and the claims. The accompanying drawings, which are incorporated in and constitute a part of this specification, illustrate embodiments of the disclosed technology and, together with the description, explain the principles of the disclosure.

### BRIEF DESCRIPTION OF THE DRAWINGS

FIG. 1 illustrates a top view of the invention in an unfolded aspect to show the six panels with their associated handles, adjustable straps, strap connectors, and extension wings.

FIG. 2 illustrates top, side and front views of the invention in folded form enclosing an item to be carried, showing the strap connections and handles in the ready-to-transport mode.

### DETAILED DESCRIPTION

### General Considerations

The apparatus described herein, and individual components thereof, should not be construed as being limited to the particular uses or applications described herein in any way. Instead, this disclosure is directed toward all novel and non-obvious features and aspects of the various disclosed embodiments, alone and in various combinations and sub-combinations with one another. For example, any features or aspects of the disclosed embodiments can be used in various combinations and sub-combinations with one another, as will be recognized by an ordinarily skilled artisan in the relevant field(s) in view of the information disclosed herein. In addition, the disclosed apparatus, and components thereof, are not limited to any specific aspect or feature or combinations thereof, nor do the disclosed uses require that any one or more specific advantages be present or problems be solved.

As used in this application, the singular forms “a,” “an,” and “the” include the plural forms, unless the context clearly dictates otherwise. Additionally, the term “includes” means “comprises.” Further, the terms “coupled” or “secured” encompass mechanical and chemical couplings, as well as other practical ways of coupling or linking items together, and do not exclude the presence of intermediate elements between the coupled items unless otherwise indicated, such as by referring to elements, or surfaces thereof, being “directly” coupled or secured. Furthermore, as used herein, the term “and/or” means any one item or combination of items in the phrase.

As used herein, the term “exemplary” means serving as a non-limiting example, instance, or illustration. As used herein, the terms “e.g.,” and “for example,” introduce a list of one or more non-limiting embodiments, examples, instances, and/or illustrations.

As used herein, the term “attached” generally means physically connected or linked, which includes items that are directly attached/coupled and items that are attached/coupled with intermediate elements between the attached/coupled items, unless specifically stated to the contrary. This may include joining with permanent adhesive, stitches, welding or other thermal bonding, and/or other joining techniques. In addition, two components may be “fixedly attached” or “fixedly coupled” by virtue of being integrally formed, for example, in a molding process. In contrast, the terms “removably attached” or “removably coupled” refer to two components joined in a manner such that the components can be readily separated from one another to return to their separate, discrete forms without destroying and/or damaging either component. Exemplary modalities of temporary attachment may include mating-type connections, releasable fasteners, removable stitches, and/or other temporary joining techniques.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the detailed description, abstract, and drawings.

### Exemplary Embodiments

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

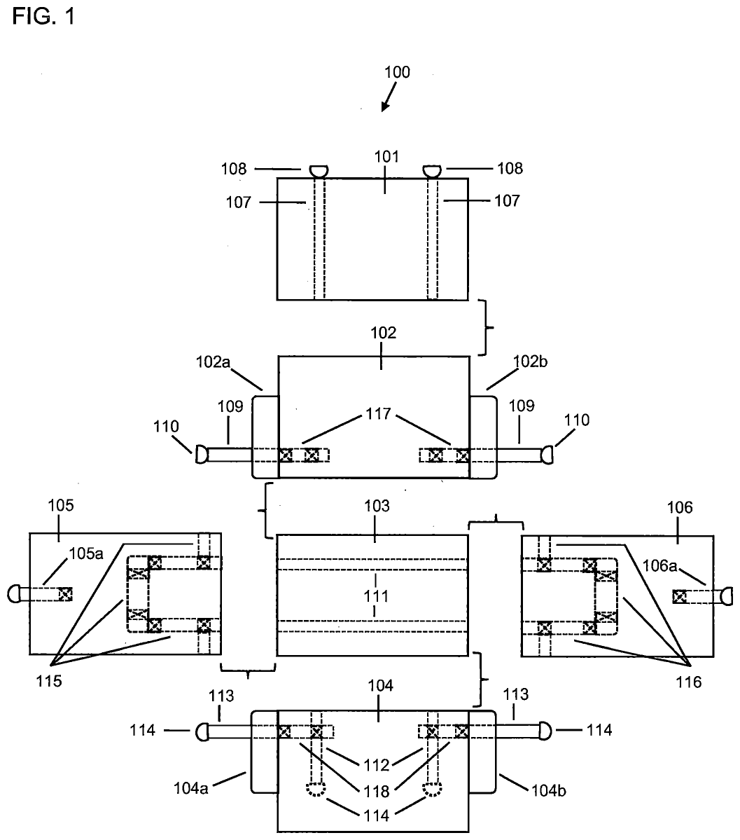

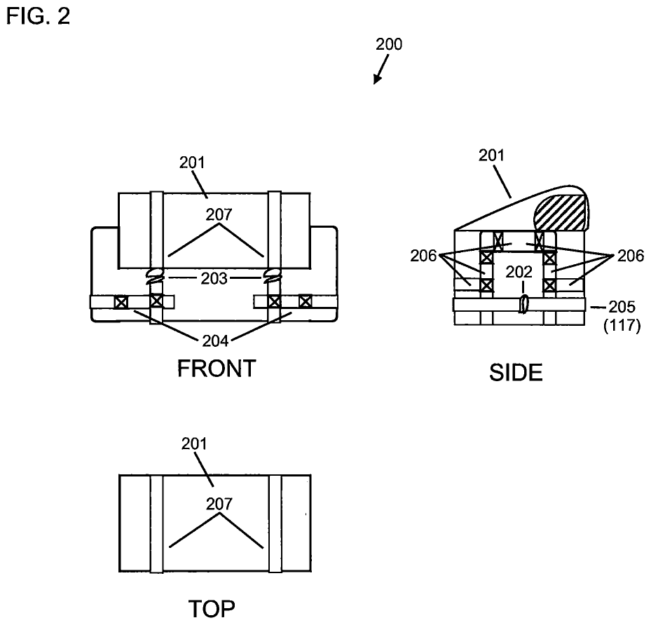

Referring now to FIGS. 1-2, a durable, reusable moving device (the apparatus) is disclosed. The moving device serves as a method of secure transport for heavy, awkward or oddly-shaped items, such as furniture or appliances of differing shapes and sizes. It is to be understood that this is merely an exemplary embodiment to describe the invention for those of ordinary skill in the art. The present invention may be used for many other difficult to move items, such as mattresses, sofas, tables and custom pieces of furniture.

An embodiment of the present invention provides a device (said apparatus) for carrying heavy, awkward, large, or oddly shaped items, the device comprising a six-paneled fabric, with all six sides, or panels, forming one contiguous piece of material, such that when folded the device approximates a rectangular prism, and when unfolded in the plane 100 lays substantially flat, comprising a center portion that when arranged vertically comprises a first panel 101, a second panel 102, a third panel 103, and a fourth panel 104, the first panel 101 being disposed above, that is, in line with, the second panel 102, the second panel 102 being disposed above the third panel 103, the third panel 103 being disposed above the fourth panel 104, and with an additional fifth 105 and sixth panel 106, each being disposed one to the left and one to the right of the third panel 103, respectively, in a manner substantially perpendicular to the center portion, and additionally, side-flaps 102a, 102b, 104a, 104b extending from left and right edges of the second 102 and fourth 104 panels respectively, and additionally, the third panel 103 being reinforced with stitched webbing 111, and attached to the first, second and forth panels are adjustable straps and connectors 107, 108, 109, 110, 112, 113, 114, attached and arranged such that there are two approximately parallel strap-connectors 107/108, 112/114, arranged along the vertical axis on each of the first and fourth panels, and further, two oppositely disposed horizontal strap-connectors 109/110, 113/114 on each of the second and fourth panels, respectively, and finally, strap handles attached and arranged vertically and horizontally on the each of the second 117, fourth 118, fifth 115 and sixth panels 116, all arranged such that when folded into a closed shape, and the opposing connectors of oppositely disposed panels are engaged, the device provides a flexible carrying apparatus adjustable in all three orthogonal spatial dimensions, securing both excess material and oppositely disposed panels.

An outer layer of the device comprises a durable fabric of water-shedding material, or even waterproof material for greatest protection. Additionally, to improve functionality, a more stretchable fabric may be used. For example, neoprene could be utilized as the outside layer due to its water resistant and durable properties, and adds more allowable stretch for any oddly-shaped furnishings or appliances that vary in size or shape in different parts of their form.

An inner portion of the device may be comprised of padding material, such as quilted fleece, to provide additional protection for the item being moved.

The inner layer is fastened together with the outer to create an inner lining that will serve to secure the item inside with minimal slip or bunching.

A method of using the moving device is described. Referring specifically to FIGS. 1-2: To utilize the moving device, a user opens all six panels of the device flat on the floor. A user would place the item to be transported on top of the third panel, denoted as the Base 103 in FIG. 1. In an example embodiment, the exemplar item to be carried may be a loveseat or similar furnishing, which is placed upright on the Base. Then a first side panel 105 (Left), is folded over on top the seat portion of the item. Next, the opposing side panel 106 (Right) is folded over onto the seating portion as well, overlapping panel 105. The Front 104 and Back 102 panels are folded up and over the front and back of the item to be carried, respectively, and the horizontal strap-connectors 113/114 and 109/110 from the Front and Back panels, respectively, are then connected as shown 202 in FIG. 2, and finally, the Top panel 101 is folded over and forward over the item as shown 201, such that strap-connectors 107/108 engage the vertical strap-connectors 112/114 of the Front panel 104, as shown 203 in FIG. 2.

At his point, there are strap-handles 204, 205, 206 available for carrying on the Front, Back and Sides, respectively, of the apparatus.

It should be understood, of course, that the foregoing relates to exemplary embodiments of the invention and that modifications may be made without departing from the spirit and scope of the invention as set forth in the following claims.

What is claimed is:

1. An apparatus for carrying items, said apparatus comprising:
a six-paneled fabric, with all six sides, or panels, forming one contiguous piece of material,
such that when folded the device approximates a rectangular prism, and when unfolded in the plane lays substantially flat,
comprising a center portion that when arranged vertically comprises a first panel, a second panel, a third panel, and a fourth panel,
the first panel being disposed above, that is, in line with, the second panel,
the second panel being disposed above the third panel,
the third panel being disposed above the fourth panel, and
with an additional fifth and six panel, each being disposed one to the left and one to the right of the third panel, in a manner substantially perpendicular to the center portion,
and additionally, side-flaps extending from left and right edges of the second and fourth panels, and additionally,
with one or more adjustable straps and connectors attached and arranged such that there are one or more approximately parallel strap-connectors arranged along the vertical axis on each of the first and fourth panels,
and further, two or more oppositely disposed horizontal strap-connectors on each of the second and fourth panels,
and finally, one or more strap handles attached and arranged vertically and horizontally on the each of the second, fourth, fifth and sixth panels,
all arranged wherein:
when said device is folded into a closed shape,
and the opposing connectors of the second and fourth panels are engaged,
as well as the opposing connectors of the first and forth panels,
the device provides a flexible carrying apparatus adjustable in all three orthogonal spatial dimensions, securing both excess material and oppositely disposed panels.

2. The apparatus of claim 1, wherein the material of said apparatus is of water-shedding, water-resistant or water-proof material.

3. The apparatus of claim 1, wherein the there is an inner layer of padded material, fixedly attached to the outer fabric layer.

4. The apparatus of claim 1, wherein the fabric comprising said apparatus is of stretchable material.

5. The apparatus of claim 1, wherein the various panels contain one or more strap handles fixedly attached in a manner parallel to one or more of each of the four edges of said panels.

6. The apparatus of claim 1, wherein the device may be constructed in a multiplicity of sizes, so as to provide a range of utility for carrying small to very large items.
